(19) United States
(12) Patent Application Publication
(10) Pub. No.: US 2008/0290563 A1
(43) Pub. Date: Nov. 27, 2008

(54) High Resolution Cold Processing Of Ceramics

(76) Inventors: Krzysztof Michal Nowak, Hiratsuka (JP); Howard John Baker, Scotland (GB); Denis Roderick Hall, Scotland (GB)

Correspondence Address: KILPATRICK STOCKTON LLP, 1001 WEST FOURTH STREET, WINSTON-SALEM, NC, 27101, US

(21) Appl. No.: 12/094,915

(22) PCT Filed: Nov. 27, 2006
(86) PCT No.: PCT/GB06/04418

§ 371 Date: May 23, 2008

(30) Foreign Application Priority Data
Nov. 25, 2005 (GB) 0524031.2

(51) Int. Cl. B29C 35/08

(52) U.S. Cl. 264/400; 425/174.4

(57) ABSTRACT

A method, material and apparatus for cold processing of ceramics wherein the ceramic contains a binder material which decomposes or otherwise produces large amounts of a gas upon heating so as to remove ablated material from the ceramic. The method, material and apparatus therefore provide self-cleaning ablation which allows for machining of ceramics at scales unachievable in the prior art.

The present invention relates to a method, a material and an apparatus for the processing of ceramics, in particular where ablated material is removed from the ablation site.

The capacity to produce precise features in ceramic materials, including low temperature co-fired ceramics (LTCCs), is of great benefit in electronics and micro-systems manufacturing and has applications in areas including avionics, the automotive industry, biomedicine, and communication systems.

LTCC, in particular, is a technology that offers excellent thermal and radio frequency (RF) properties, excellent potential for optoelectronic hybrids, is compatible with silicon and is well adapted to the so-called ‘meso’ scale (10 μm to 100 μm) [as discussed in Gongora-Rubio et al, Sens. Actuator A-Phys., 89, 222-24 (2001), Thelemann et al, Microelectron. Int., 19, 19-23 (2002), and Horowitz et al, Photonics Spectra, 35:123 (2001)].

LTCC materials are generally manufactured using composite glass-ceramic materials, and can be easily and inexpensively fabricated in a ‘green’ (i.e. unfired) state for use in multi-layered designs.

This allows, for example, the integration of passive R-L-C (resistive-inductive-capacitive) components into a printed circuit board (PCB). Within this area of technology, the interconnect between layers is achieved using microvias and cutouts, which are drilled or cut in the so-called green state material and filled with appropriate ink materials prior to firing.

As described earlier, LTCCs are generally manufactured using composite glass ceramic materials.

In practice, green tape LTCCs are generally implemented in the form of a composite consisting of an alumina ceramic filler and glass frit particles, that allow a lower sintering temperature, held together with an organic binder which also acts as a viscosity controller prior to sintering.

LTCC processing is carried out in its green state and is currently dominated by mechanical punching for vias, and CNC machining for larger slots. However, mechanical methods are limited in hole diameter and density and are subject to wear due to tool/workpiece physical contact [as described in Gongora-Rubio et al, Sens. Actuator A-Phys., 89, 222-24 (2001), and Kestenbaum et al, 13, 1055-1062 (1990)].

Although LTCCs have been in use for more than a decade, laser machining of green state material is not generally known to take place within industry, and little has been reported in regard to the possibilities of using such a method. When this technology has been examined, problems have been evident.

In 1999 Imen and Allen [as described in Imen et al, IEEE Trans. Advanced Packaging, 22, 620-62 (1999)] reported using a TEA CO₂ laser to machine green alumina sheets, and found air breakdown over the ablation site, due to the high peak power employed, and plasma screening to be a major problem. Operating at reduced pressures alleviated the problem, and a material removal rate of 30 μm to 40 μm per pulse at 100 j·cm⁻² was reported, though large values of fluence (1.2 to 1.5 kJ·cm⁻²) were required to achieve this.

Nd:YAG lasers at 1.06 μm have been used for drilling 75 μm to 500 μm diameter holes in LTCC with a reasonable level of quality and at reasonable pulse rates, but the material removal rate and overall machining control were found to be low, and thus generally unsuitable for an industrial process due to relatively weak absorption at this wavelength [see Guo et al, European Ceram. Soc., 23, 1263-1267 (2003), and Kita et al, Microelectron. Int., 19, 14-18, (2002)].

Slocombe et al [Appl. Surf. Sci., 168, 21-24 (2000)] reported diode laser machining of a polymer/Al2O3 composite material, but found that absorption at 852 nm was too low and coloured pigments were required to increase optical absorption of the composite to a suitable level.

Therefore it can be said that the current state of the art in regard to the laser machining of ceramics does not allow such machining to take place at low temperatures and laser power levels, or with high resolution or high speed.

According to a first aspect of the present invention, there is provided a method for ablating a ceramic, the ceramic comprising particles within a binder, the method comprising heating a volume of the ceramic so as to cause the binder within the volume to produce a gas in which the particles are freed and expansion of which causes removal of particles within the volume from the ceramic.

Preferably, heating the ceramic causes the gas to be formed by decomposition of the binder.

Preferably, decomposition occurs by pyrolysis.

Alternatively, heating the ceramic causes the gas to be formed by sublimation of the binder.

Alternatively, heating the ceramic causes the gas to be formed by melting and evaporation of the binder.

Preferably, heating the ceramic comprises localised heating of the ceramic.

Preferably, the ceramic is heated by means of a laser, the laser output being incident on the ceramic.

Preferably, the laser is pulsed.

Preferably, heating the ceramic also comprises controlling the output of the laser.

Preferably, controlling the output of the laser includes controlling parameters of the laser output selected from the group of intensity, pulse width, pulse duration, beam profile, direction, wavelength and divergence.

Optionally, an acousto-optic modulator in the beam line of the laser controls the output of the laser.

Preferably, the ceramic is heated and parameters of the laser varied in accordance with a predetermined sequence.

Alternatively, the ceramic is heated by a microwave source.

Preferably, the binder is selected to decompose controllably and produce gas at temperatures below the melting point of the particles.

Alternatively, the binder is selected to sublimate controllably and produce gas at temperatures below the melting point of the particles.

Preferably, the particles have a higher heat absorption rate than the binder.

Preferably, the particles are capable of transferring thermal energy to the surrounding binder.

Preferably, the binder is a resin.

Preferably, the binder is an organic polymer, such as polyvinyl butyral (PVB), polyvinyl alcohol (PVA), polymethyl methacrylate (PMMA) and other used in industry, or mixture there of.

Optionally, the particles comprise one or more of glass, metal, ceramic and other materials of choice, in the form of micro- and/or nano-meter size particles.

Preferably, the particles comprise alumina.

Preferably, the particles comprise glass frit.

Preferably, the material is a low temperature co-fired ceramic.

Preferably, the low-temperature co-fired ceramic is in its green state.

Preferably, the method further comprises controlling one or more parameters selected from the temperature to which the material is heated, the location of heating, the duration of heating, the shape of the area being heated, and the movement of the location of heating.

Optionally, the parameters are controlled in accordance with a predetermined pattern, so as to ablate the material to conform to the pattern.

Optionally, the method further comprises extracting ejected particles.

Optionally, the method further comprises moveably locating the material relative to the heating means.

Optionally, the method further comprises acquiring images of the material during ablation.

According to a second aspect of the present invention, there is provided a ceramic material for ablation, the material comprising particles within a binder, wherein the binder is selected to produce gas upon heating which causes removal of particles from the ceramic.

Preferably, heating the ceramic causes the gas to be formed by decomposition of the binder.

Preferably, decomposition occurs by pyrolysis.

Alternatively, heating the ceramic causes the gas to be formed by sublimation of the binder.

Alternatively, heating the ceramic causes the gas to be formed by melting and evaporation of the binder.

Preferably, the binder is selected to decompose controllably and produce gas at temperatures below the melting point of the particles.

Alternatively, the binder is selected to sublimate controllably and produce gas at temperatures below the melting point of the particles.

Preferably, the particles have a higher heat absorption rate than the binder.

Preferably, the particles are capable of transferring thermal energy to the surrounding binder.

Preferably, the binder is a resin.

Preferably, the binder is an organic polymer, such as polyvinyl butyral (PVB), polyvinyl alcohol (PVA), polymethyl methacrylate (PMMA) and other used in industry, or mixture there of.

Optionally, the particles comprise one or more of glass, metal, ceramic and other materials of choice, in the form of micro- and/or nano-meter size particles.

Preferably, the particles comprise alumina.

Preferably, the particles comprise glass frit.

Preferably, the material is a low temperature co-fired ceramic.

Preferably, the low-temperature co-fired ceramic is in its green state.

According to a third aspect of the present invention, there is provided an apparatus for carrying out the method of ablation of a ceramic in accordance with the first aspect on a ceramic material in accordance with the second aspect, wherein the apparatus comprises a heating means adapted to heat the ceramic.

Preferably, the heating means provides localised heating to the ceramic.

Preferably, the heating means is a laser.

Preferably, the heating means is a CO₂ laser.

Preferably, the laser is pulsed.

Alternatively, the heating means is a microwave source.

Alternatively, the heating means comprises a probe with a heated tip adapted to be placed on or near the ceramic.

Alternatively, the heating means comprises a probe adapted to produce an electrical arc with the ceramic.

Preferably, the apparatus further comprises control means adapted to control the heating means.

Preferably, the control means controls one or more parameters selected from the temperature to which the material is heated, the location of heating, the duration of heating, the shape of the area being heated, and the movement of the location of heating.

Optionally, the parameters are controlled in accordance with a predetermined pattern, so as to ablate the ceramic to conform to the pattern.

Optionally, the control means comprises an acousto-optic modulator in the beam line of a laser forming the heating means.

Optionally, the apparatus further comprises an extraction means for extracting ejected particles.

Optionally, the apparatus further comprises a positioning stage for moveably locating the ceramic relative to the heating means.

Optionally, the apparatus further comprises imaging means for acquiring images of the ceramic during ablation.

The present invention will now be described by way of example only and with reference to the accompanying figures in which:

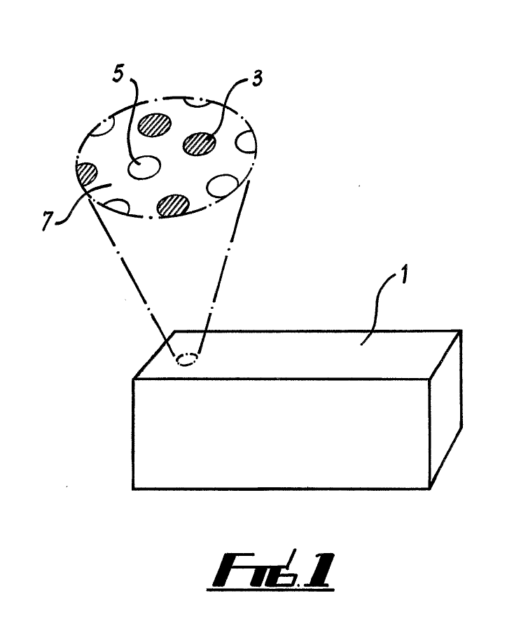

FIG. 1 illustrates in schematic form a ceramic block representative of an aspect of the present invention;

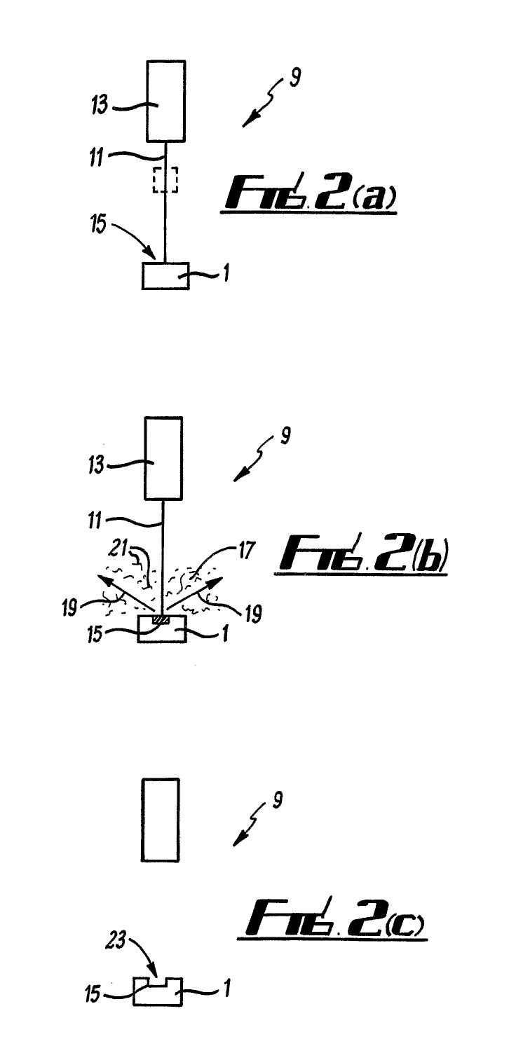

FIG. 2 illustrates in schematic form the apparatus forablation of a ceramic block such as that illustrated in FIG. 1, in accordance with an aspect of the present invention;

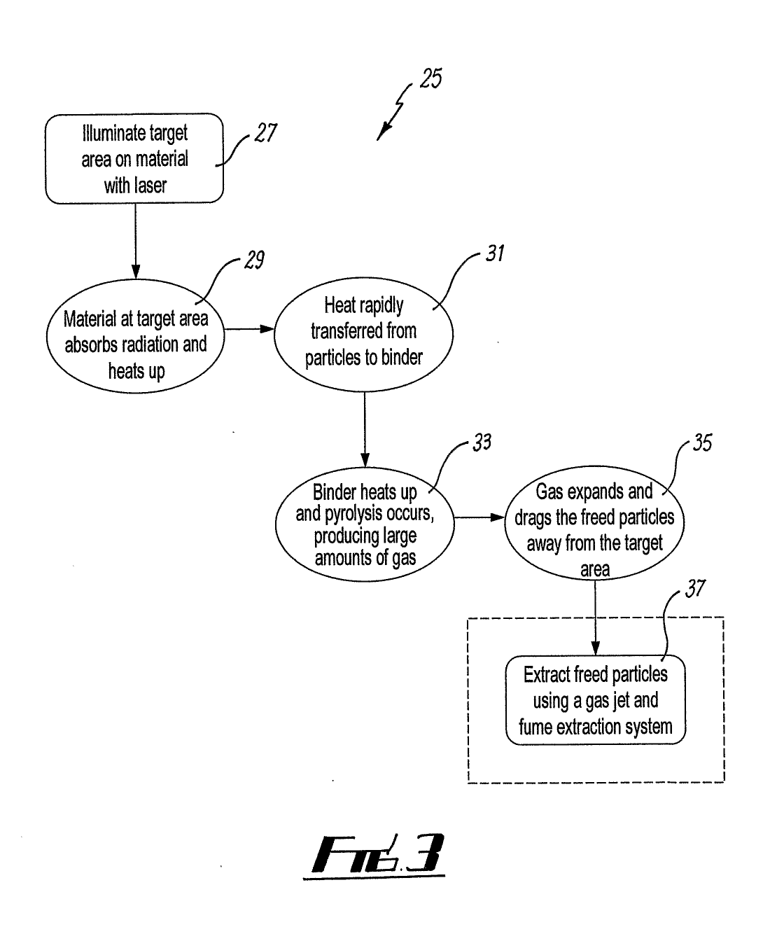

FIG. 3 illustrates, by way of a flowchart, the method of ablation described with reference to FIG. 2, in accordance with an aspect of the present invention;

FIG. 4 is a scanning optical profilometer image of three adjacent craters made in accordance with an aspect of the present invention;

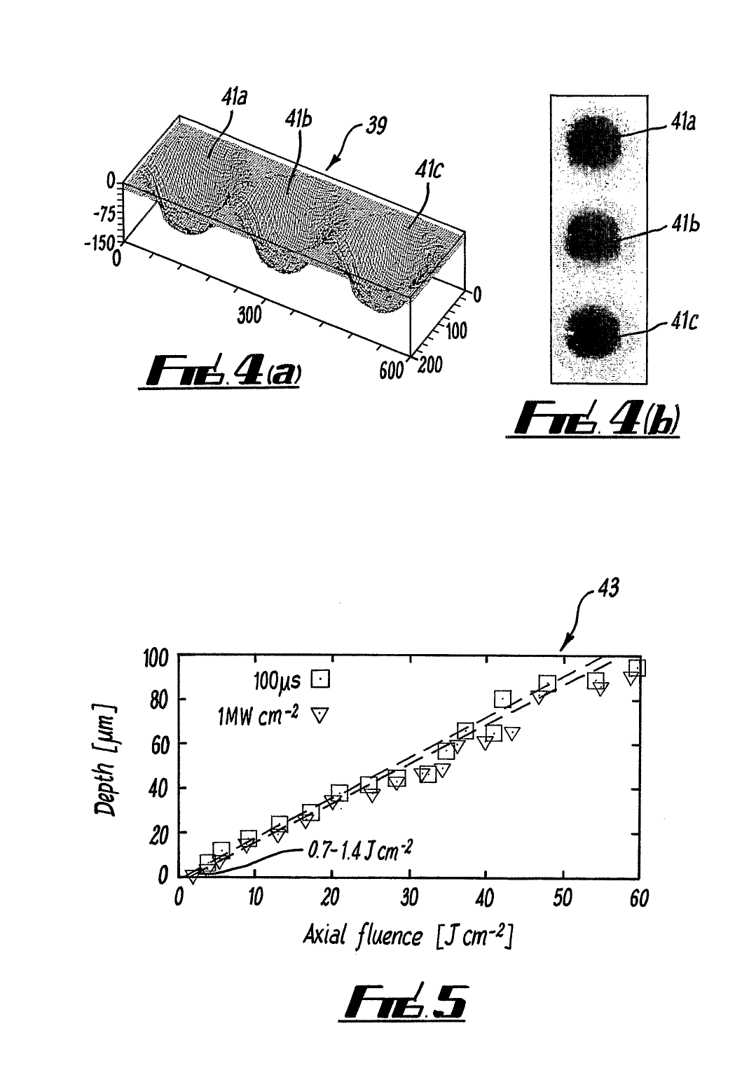

FIG. 5 illustrates graphically the laser ablation characteristics of Heralock HL2000 green tape;

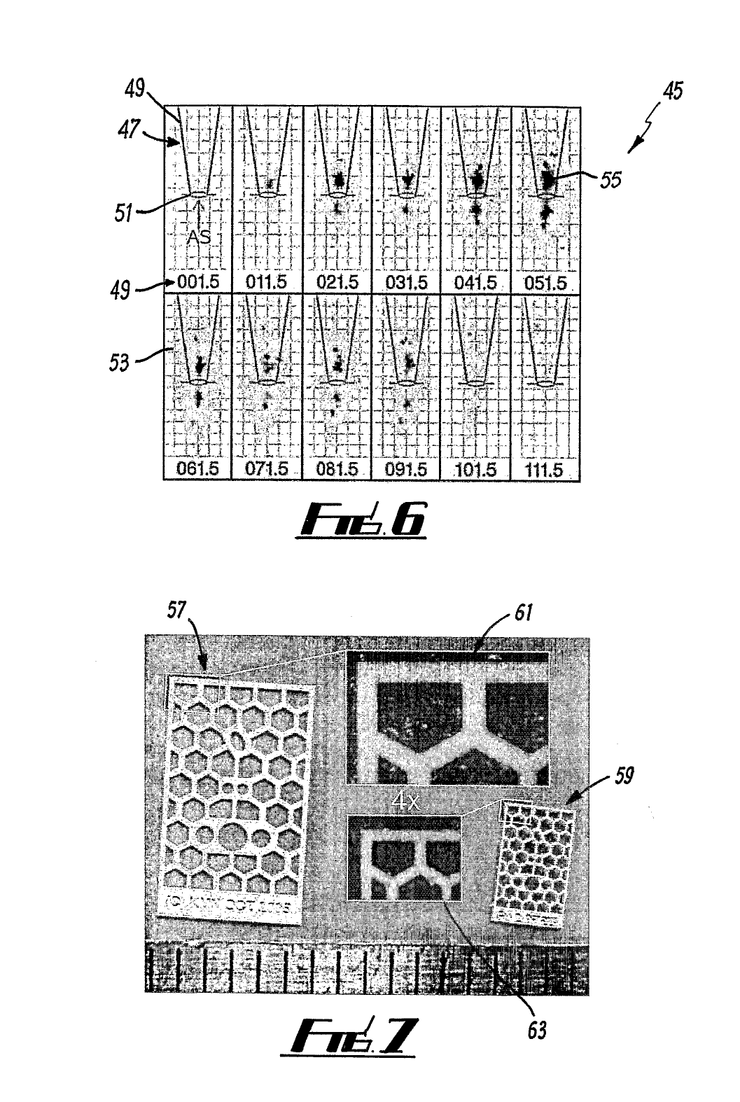

FIG. 6 is a series of frames from an ultrafast camera recording laser ablation of the green tape of FIG. 5; and

FIG. 7 is an illustration of a mesh structure, made in accordance with an aspect of the present invention and demonstrating the process capability of the present invention.

With reference to FIG. 1, there is presented a ceramic block 1, formed in accordance with an aspect of the present invention. The block 1 is a green state low temperature co-fired ceramic material (LTCC), comprising alumina 3 and glass 5 particles within a polymer binder 7.

In this example, the binder 7 is selected to have a pyrolysis point which is lower than the melting point of the alumina 3 and glass 5 particles, and to have a significantly lower heat absorption rate. This means that the binder 7 is able to decompose to produce a gas at a much lower temperature than the particles 3, 5 will melt or decompose at. Although the alumina 3 and glass 5 particles are selected to have higher heat absorption qualities, the binder 7 still has a high level of heat absorption. Having a high level of heat absorption in the particle 3, 5 content allows for exceptional machining accuracy and very low energetic requirements. Furthermore, heat energy can be coupled into the material in a highly localised manner.

In this example, any suitable particle or binder may be selected, provided the particle has a higher melting point than the binder. When heated the binder is thus able to produce large quantities of gas at temperatures below that at which the particles will melt.

The expanding gas also drags with it the freed particles of ceramic and glass from the ablation site, resulting in a “self-cleaned” ablation hole without the need for any external extraction.

It is also envisaged that this technique could similarly apply where the binder is selected to produce gas (upon application of heat) by sublimation rather than by pyrolisis, or even by melting and subsequent evaporation of the binder or a constituent thereof.

FIG. 2 illustrates an apparatus 9 for ablating the ceramic block 1 of FIG. 1. The output 11 from a CO₂ laser 13 is focussed onto the ceramic block 1 and impinges on the target area 15 for ablation (FIG. 2(a)). The CO₂ laser 13 produces high power infrared pulses which, in combination with the high level of heat absorption, couples substantial amounts of energy into the material.

The particles are thus rapidly heated by the incoming pulse of laser light, and this thermal energy is also quickly transferred into the binder. The binder is thus heated until reaches its pyrolysis point and decomposes (FIG. 2(b)). This produces large amounts of gas 17, further energised by heating, with an expansion of the gas 17 away from the ablation site (see arrows ref 19).

The expanding gas 17 also drags with it the freed particles 21 of ceramic and glass from the ablation site, resulting in a “self-cleaned” ablation hole 23 (FIG. 2(c)) without the need for any external extraction.

FIG. 3 schematically presents the process 25 outlined above. The area to be ablated is illuminated using a laser 27 (in this case a CO₂ laser) and the material in the target area is heated up as the infrared radiation is absorbed 29. As mentioned above, the heat is rapidly transferred from the particulate material to the binder 31.

The binder heats up to the point of pyrolysis at which large amounts of gases are released 33, expanding away from the target site and dragging loosed ceramic and glass particles with it 35.

To assist in the removal of the ejected material, a gas jet and fume extraction system may be employed 37. This serves to remove the freed particles but the gas expansion cleans the ablation site automatically without the need for the secondary extraction system.

Another embodiment of the present invention is now described in which a laser machining workstation, similar to that used for laser polishing of silica, is used.

This implementation makes use of an RF-excited planar waveguide CO₂ laser capable of a 100 W output in a near-Gaussian beam profile with an M² value of 1.1, although the required processing power in the case of this embodiment was 10 W on average.

The beam is focused on a workpiece with optics that provided beam spot diameters in the range from 47-1000 microns, as illustrated schematically in FIG. 4(a). The workpiece is mounted on a precision (100 nm resolution) X-Y positioning stage which has a maximum translation speed of 50 mm·s⁻¹.

An acousto-optic modulator in the beam line is used to control the laser intensity and pulse duration. This control enables the systematic collection of material removal data which can be correlated with the laser parameters.

The material is a LTCC green tape. The particular type employed was zero-shrinkage Heralock HL2000 (CL-91-8242, Heraeus Inc.) of nominal thickness 130 μm. For the purposes of characterisation, the binder from the Heralock tape was extracted and it was determined that its ablation characteristics are nearly identical with those of the binder polyvinyl butyral (PVB), Butvar-98 which is frequently used in industry.

The material employed for machining was a combination of (predominantly) Al₂O₃ (alumina), and glass frit particles. The optical absorption coefficient of Al₂O₃ and most glasses at 10.6 μm is about an order of magnitude larger than that of PVB. Therefore the temperature of the ceramic/glass particles will rise significantly faster than that of the surrounding binder.

Above a certain temperature threshold, in this case 200-400° C., pyrolysis is the dominant mechanism for the polymer decomposition, producing a number of volatile and flammable organic species such as butanal, benzene, acetal and butanol (in the case of PVB). However, the Al₂0₃ particles remain unaffected in this manner, as their melt temperature is >1500° C.

Using the apparatus and tape described above, a large number of craters were laser written in the green LTCC material. The craters were organised in groups of identical settings of pulse energy and duration. By varying the pulse energy and pulse duration a wide range of operating conditions can be, and have been, characterised.

The average depth of the craters in each group was mapped systematically using the optical profiler for each set of operational conditions.

FIG. 4 illustrates the three dimensional profile of a laser machined sample 39. The profile was acquired using a raster-scan profiler based on an optical depth probe (STIL Model CHR-450) integrated into the machining facility for provision of online diagnostics and measurement. The operating software was responsible for profiling the material removal carried out in the course of experiments with lateral and vertical accuracy about 1 μm and a data rate of ˜1 kHz.

The crater profiles, acquired by the non-contact optical profilometer, show a set of three typical craters 41a,b,c, each obtained with identical single laser pulses (spot diameter of 141 μm, axial irradiance of 1 MW·cm⁻², pulse duration of 150 μs, axial fluence 150 J·cm⁻² and at 500 Hz pulse repetition frequency).

FIG. 4(a) in particular depicts an isometric 3D profile image showing well formed and repeatable craters 41a,b,c obtained at a high etch rate and which are virtually free from debris. The craters display no evidence of heat affected zones or of interference between the adjacent craters. FIG. 1(b) presents a top-down view of the craters as a grey-scale depth map.

The plot of etch depth versus laser pulse fluence 43, shown in FIG. 5, indicates a high-speed, low-energy material removal process.

LTCC green tape (Heralock HL2000 has a planar layered internal structure with a 50-60 μm thick alumina core sandwiched in 30-40 μm thick silicate-rich outer layers. This structure is responsible for its zero-shrinkage property.

The invention is thus applicable with equal success to the typical bulk formulations and materials with a layered structure incorporating one or more layers of different composition.

The described embodiment also shows that features as deep as a few hundred microns can be drilled in the green material using single CO₂ laser pulses with only modest energy requirements.

To determine the optimum irradiance conditions for this example, experiments were conducted at constant fluence (15 j·cm⁻²) while varying the pulse duration.

The results indicated a threshold value of 0.04 MW·cm⁻², below which there is an insufficient pressure build-up of volatile decomposition products and correspondingly low gas escape and particle drag. The material removal rate peaked at around 0.2 W·cm⁻² above which the removal rate fell, possibly due to particle congestion or the onset of plasma screening.

Direct experimental evidence supporting the present invention's performance of “cold” material removal was obtained by the visual observation of the ablation process using the high-speed imaging camera.

FIG. 6 illustrates an image sequence 45 of the interaction of the laser pulse with a green LTCC material 47 captured by a high-speed framing camera at a low grazing incidence angle (<5°). The camera employed in this example was a DRS Hadland Ultra 68, capable of producing sequences of 68 frames with exposure times as short as 10 ns at up to 500,000 frames/sec (with a flat spectral sensitivity in the range 400-850 nm). The resolution in the image plane was 32 lines/mm, with a depth of focus of 300 μm. The working distance of the camera and microscope was ˜5.5 cm.

The frames are taken from a sequence acquired at 400,000 frames/sec, with an exposure time of 2 μs. The time (e.g. ref 49) indicated in each frame is counted from the beginning of the laser pulse which irradiated the material 47 at 0.15 MW·cm⁻² (fluence −15 J·cm⁻², spot diameter—165 μm) for a period of 100 μs. An outline of the laser beam 49, the location of ablation site 51 and a 100 μm square grid 53 have been overlaid on each frame for reference and measurement purposes.

The images illustrate clearly that the ablation process was ‘cold’, since there is no incandescence observable at the ablation site 51, in direct contrast to the case of laser ablation of fired ceramics, where incandescent melt pools are known to exist within the crater itself.

High-speed videography, as exemplified by FIG. 6, reveals that it is only after ejection from the irradiation site that the alumina/glass particles (e.g. ref 55) may be heated beyond melting as they transit the incoming laser beam 49. This has no thermal effects on the machined feature, so justifying the designation of the present invention as a ‘cold’ process.

The example described above was carried out in air at atmospheric pressure without any gas jet assist, and the resulting holes were substantially debris free with only few particles scattered around the machining site.

The inherent self-cleaning is a direct consequence of the removal mechanism thanks to the creation of a relatively large amount of decomposition gases, which act as a carrier for the nearly-buoyant ceramic particles.

In case of processing other material formulations using the present invention, such as metal/polymer, processing could be achieved with a higher machining threshold. This threshold would be higher by about an order of magnitude, around 10-100 J·cm⁻² at 10.6 microns. When compared to the thresholds known in the art (typically >3000 J·cm⁻² at 1.06 microns—e.g. Nd:YAG) a benefit is clear. Additionally, if processing was carried out using a CO₂ laser, much better surface quality and accuracy could be achieved than at 1.06 microns, because the binder absorbs heat more efficiently than the metal particles at 10.6 microns.

Numerous advantages are to be had as a result of employing the present invention.

As mentioned above, during the ablation process itself the particles are still effectively “cold”, since the binder pyrolysis temperature can be far lower than the melting point of the particles. Consequently the present invention ensures that there practically no heat-affected zones at the ablation site.

The present invention can also be said to be ‘cold’ in the sense that no molten particle material is produced, so avoiding undesirable heat-effected zone spatter and limited feature quality evident in conventional processing of both fired and green ceramic materials.

The capacity of this machining process to operate at high resolution and to process arbitrary-shaped machined features is illustrated by the examples of the structures 57, 59 shown in FIG. 7 that were machined in green state LTCC using the present invention and subsequently fired at 865° C. according to manufacturer's recommendations. No cracking and little or no warping was observed upon unconstrained firing. The resulting structures 57, 59 were characterised by feature forms, sizes and aspect ratios unachievable by current industrial methods of green ceramic processing (see zoomed portions 61, 63).

The present invention in particular enables the rapid drilling of high spatial density microvias at rates of thousands per second, and can produce arbitrary feature shapes with lateral resolution down to <50 μm and depth resolution comparable to the ceramic particle grain size.

Existing non-contact machining techniques that allow for similar degrees of precision, such as UV laser machining, do not deliver productivity sufficient for successful industrial applications. Other techniques, such as Nd:YAG laser machining, do not produce sufficient control and precision as compared to the present invention.

The present invention therefore has applicability to all types of composites whose constituent parts differ sufficiently in decomposition temperatures, but in particular to organic/inorganic composites. In particular, it can produce arbitrary shaped features with high resolution in green ceramic composites, and therefore has application in the fabrication of advanced devices, for example in electronics, sensors and Microsystems.

The present invention provides a novel powerful ‘cold’ self-cleaning method for the processing of ceramics, preferably in their green state (and especially LTCCs), at high resolution and high speed using a low power laser or such like, preferably a carbon dioxide laser.

Any suitable particle or binding agent may be employed within the material to be machined.

It is also preferable that the binder used within the material decomposes controllably upon the application of heat and produces, preferably large, quantities of gases at temperatures below the melting point of the particles, ideally by pyrolysis. The gas may however be formed by rapid melting and evaporation of the binder or by sublimation of the solid binder. A high level of heat absorption in the binder is welcome, but not necessary.

Within the present invention, it is preferable that the levels of heat absorption in the particle content are high, as this promotes machining accuracy and very low energetic requirements, and allows for substantial amounts of energy to be transferred to the material in a highly localised manner.

The described example above refers to a ceramic in the form of an LTCC, made up of an organic polymer binder and particles in the form of glass and an alumina ceramic. However, these are to be seen as preferable and therefore not to limit the scope of the invention.

As it is the pyrolysis of the binder that provides the driving force for the removal process, the processing of other material compositions, such as metal/polymer composites, or green state standard alumina (AL₂O₃) is also possible.

Utilising certain characteristics of the material itself, being made up of particles and a binder, allows it to be machined in accordance with the invention. Any laser may be utilised for the machining, provided that the heat generated by the laser is sufficient to cause decomposition of the binder, but insufficient to cause melting of the other particles.

CO₂ laser radiation is preferable as this, in combination with a high level of heat absorption in the ceramic particles, promotes exceptional machining accuracy and very low energetic requirements, with a machining threshold of 1-10 J·cm⁻², allowing for substantial amounts of energy to be transferred in a highly localised manner from the practical CO2 laser pulse.

The inverse optical absorption coefficient, or absorption length, in the composite material to be machined, preferably an LTCC, should beneficially be comparable with the particle size to assure the optimal machining accuracy.

A comparison of optical absorption coefficients at a given wavelength and the typical volumetric heat capacity of the material constituents, the binder and the glass/ceramic particles as described earlier, should show that the particles will increase in temperature at a rate generally higher then that of the surrounding binder.

Should the binder heat up faster than the particles the present invention will not be prevented from being carried out, but will rather lead to a non-optimal performance of the invention in terms of machining precision and/or energetic requirements and/or self-cleaning.

The binder in the material, preferably an organic binder as described earlier, for example polyvinyl butyral (PVB), should decompose above a certain point, about 300° C. in the case of PVB. This temperature should be lower, preferably considerably lower, than the melting point of the particles in the material.

Utilising these characteristics, one embodiment of the present invention consists of a three stage particle ablation and ejection method that involves the particles, preferably alumina and glass, and binder, preferably a polymer, present in the material, preferably a green LTCC.

In the first stage, a material, such as a green state LTCC made up of particles and a binder, is illuminated by laser light, or similar source of localised non-contact heating, the heat from which is absorbed in the material.

In the second stage this heat is rapidly transferred from the particles, such as ceramic and glass particles, to the surrounding binder, which may be an organic polymer. The binder soon exceeds its pyrolysis point and rapidly decomposes. The particles do not melt at that temperature due to their higher, typically significantly higher, melting point.

This rapid decomposition of the binder then creates gases at rates large enough to initiate the third stage of the present invention. The constituent in the binder material should decompose at a relatively low temperature and produce large amount of gas when doing so. Melting of the binder alone without the production of gas will produce splashing and spatter similar to that produced during known laser machining of fired ceramics.

In the third stage the expanding gases drag the freed, nearly buoyant, ceramic and glass particles away from the ablation site. In this way the present invention can be said to be self cleaning.

Although any heat source may be employed, and although laser light is preferable, for optimum performance the heat source should operate above an intensity point sufficient to allow optimum heat transfer from the particles to the binder without damaging the surrounding particles and to allow sufficient pressure build-up of volatile decomposition products, whilst taking account of the user's preferred levels of energy use.

Also, to ensure optimal throughput, optimal post-process surface quality and optimal self cleaning operation within the present invention, it is preferable not to drill very deep structures using a single pulse, since an interaction length of the beam and the ejected particles increases with ablation depth. Rather, it is preferable to drill large depths by way of a number of separate pulses of smaller fluence to allow the beam path to be cleared of decomposition products, made up of particle dust generated during and after laser interaction. This ‘fallout’ can generally be prevented from re-depositing by carrying out the process at the higher intensity region of the machining window to assure high escape velocity of the machining debris, but also by an application of additional gas jet and a fume extraction system.

In summary, the present invention provides a ‘cold’ non-contact machining process, preferably implemented using a carbon dioxide laser, although any controllable and targeted heat source could be used, capable of machining high-quality features (<50 μm) at rates of thousands/sec in materials, preferably green ceramic materials containing glass and ceramic particles held together by an organic polymer binder, although any particle/binder combination could be used provided the melting points of the particle is sufficiently higher that binder decomposition temperature, with negligible thermal effects at the machining site. The present invention is enabled through the exploitation of a heat transfer to the binder and the gas generating capacity of a binder leading to an effective particle ejection mechanism.

The present invention has applicability to all types of composites whose constituent parts melt at differing levels, but in particular to organic/inorganic composites. In particular, it can produce arbitrary shaped features with high resolution in green ceramic composites, and therefore has application in the fabrication of advanced devices, for example in electronics, sensors and microsystems.

In addition, any apparatus capable of heating the material and causing the binder to produce a gas may be employed—for example a microwave source or an electrical discharge such as that from a highly charged probe.

Further modifications and improvements may be added without departing from the scope of the invention as defined by the appended claims.

1. A method for ablating a ceramic, the ceramic comprising particles within a binder, the method comprising heating a volume of the ceramic so as to cause the binder within the volume to produce a gas in which the particles are freed and expansion of which causes removal of particles within the volume from the ceramic.

2. The method of claim 1 wherein, heating the ceramic causes the gas to be formed by decomposition of the binder.

3. The method of claim 2 wherein, decomposition occurs by pyrolysis.

4. The method of claim 1 wherein, heating the ceramic causes the gas to be formed by sublimation of the binder.

5. The method of claim 1 wherein, heating the ceramic causes the gas to be formed by melting and evaporation of the binder.

6. The method of claim 1 wherein, heating the ceramic comprises localised heating of the ceramic.

7. The method of claim 1 wherein, the ceramic is heated by means of a laser, the laser output being incident on the ceramic.

8. The method of claim 7 wherein, the laser is pulsed.

9. The method of claim 7 wherein, heating the ceramic also comprises controlling the output of the laser.

10. The method of claim 9 wherein, controlling the output of the laser includes controlling parameters of the laser output selected from the group of intensity, pulse width, pulse duration, beam profile, direction, wavelength and divergence.

11. The method of claim 9 wherein, an acousto-optic modulator in the beam line of the laser controls the output of the laser.

12. The method of claim 7 wherein, the ceramic is heated and parameters of the laser varied in accordance with a predetermined sequence.

13. The method of claim 1, the ceramic is heated by a microwave source.

14. The method of claim 1 wherein, the binder is selected to decompose controllably and produce gas at temperatures below the melting point of the particles.

15. The method of claim 1 wherein, the binder is selected to sublimate controllably and produce gas at temperatures below the melting point of the particles.

16. The method of claim 1 wherein, the particles have a higher heat absorption rate than the binder.

17. The method of claim 1 wherein, the particles are capable of transferring thermal energy to the surrounding binder.

18. The method of claim 1 wherein, the binder is a resin.

19. The method of claim 1 wherein, the binder comprises one or more organic polymers.

20. The method of claim 19 wherein, the one or more organic polymers are selected from the group of polyvinyl butyral (PVB), polyvinyl alcohol (PVA), and polymethyl methacrylate (PMMA).

21. The method of claim 1 wherein, the particles comprise one or more of glass, metal, ceramic.

22. The method of claim 1 wherein, the particles are of micro-meter size.

23. The method of claim 1 wherein, the particles are of nano-meter size.

24. The method of claim 1 wherein, the particles comprise alumina.

25. The method of claim 1 wherein, the particles comprise glass frit.

26. The method of claim 1 wherein, the material is a low temperature co-fired ceramic.

27. The method of claim 26 wherein, the low-temperature co-fired ceramic is in its green state.

28. The method of claim 1 wherein, the method further comprises controlling one or more parameters selected from the temperature to which the material is heated, the location of heating, the duration of heating, the shape of the area being heated, and the movement of the location of heating.

29. The method of claim 28 wherein, the parameters are controlled in accordance with a predetermined pattern, so as to ablate the material to conform to the pattern.

30. The method of claim 1 wherein, the method further comprises extracting ejected particles.

31. The method of claim 1 wherein, the method further comprises moveably locating the material relative to the heating means.

32. The method of claim 1 wherein, the method further comprises acquiring images of the material during ablation.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. An apparatus for carrying out a method for ablating a ceramic, the ceramic comprising particles within a binder, the method comprising heating a volume of ceramic so as to cause the binder within the volume to produce a gas in which the particle are freed and expansion of which causes removal of particles within the volume of the ceramic, wherein the apparatus comprises a heating means adapted to heat the ceramic.

53. The apparatus of claim 52 wherein, the heating means provides localised heating to the ceramic.

54. The apparatus of claim 52 wherein, the heating means is a laser.

55. The apparatus of claim 54 wherein, the heating means is a CO₂ laser.

56. The apparatus of claim 54 wherein, the laser is pulsed.

57. The apparatus of 52 wherein, the heating means is a microwave source.

58. The apparatus of claim 52 wherein, the heating means comprises a probe with a heated tip adapted to be placed on or near the ceramic.

59. The apparatus of claim 52 wherein, the heating means comprises a probe adapted to produce an electrical arc with the ceramic.

60. The apparatus of claim 52 wherein, the apparatus further comprises control means adapted to control the heating means.

61. The apparatus of claim 60 wherein, the control means controls one or more parameters selected from the temperature to which the material is heated, the location of heating, the duration of heating, the shape of the area being heated, and the movement of the location of heating.

62. The apparatus of claim 61 wherein, the parameters are controlled in accordance with a predetermined pattern, so as to ablate the ceramic to conform to the pattern.

63. The apparatus of claim 60 wherein, the control means comprises an acousto-optic modulator in the beam line of a laser forming the heating means.

64. The apparatus of claim 52 wherein, the apparatus further comprises an extraction means for extracting ejected particles.

65. The apparatus of claim 52 wherein, the apparatus further comprises a positioning stage for moveably locating the ceramic relative to the heating means.

66. The apparatus of claim 52 wherein, the apparatus further comprises imaging means for acquiring images of the ceramic during ablation.
